(19) United States
(12) Patent Application Publication
(10) Pub. No.: US 2024/0357401 A1
(43) Pub. Date: Oct. 24, 2024

(54) Managing Configured Application-Layer Measurements in Response to a Connection Set-Up Message

(71) Applicant: Telefonaktiebolaget LM Ericsson (publ), Stockholm (SE)

(72) Inventors: Cecilia Eklöf, Täby (SE); Ali Parichehrehteroujeni, Linköping (SE); Luca Lunardi, Genoa (IT); Mattias Bergström, Sollentuna (SE); Filip Barac, Huddinge (SE); Johan Rune, Lidingö (SE)

(21) Appl. No.: 18/684,626

(22) PCT Filed: Aug. 17, 2022
(86) PCT No.: PCT/SE2022/050752

§ 371 Date: Feb. 16, 2024

Related U.S. Application Data
(60) Provisional application No. 63/233,977, filed on Aug. 17, 2021.

(51) Int. Cl. H04W 24/10; H04W 76/19; H04W 76/27; H04W 80/12

(52) U.S. Cl. CPC H04W 24/10; H04W 76/19; H04W 76/27; H04W 80/12

(57) ABSTRACT

Embodiments include methods for a user equipment (UE) configured for application-layer measurements in a radio access network (RAN). Such methods include receiving one or more configurations of application-layer measurements to be performed by the UE while the UE is connected to the RAN and, in response to an interruption in the UE's connection to the RAN while the CE is configured to perform the application-layer measurements, sending to the RAN a request to resume the UE's connection or a request to reestablish the UE's connection. Such methods also include, in response to the request sent to the RAN, receiving from the RAN a command to setup a new connection to the RAN and in response to the command, releasing the received configurations and discarding any stored application-layer measurement reports. Other embodiments include complementary methods for RAN nodes, as well as UEs and RAN nodes configured to perform such methods.

### TECHNICAL FIELD

The present disclosures relates generally to wireless networks, and more specifically to how a user equipment (UE) manages configured and/or ongoing application-layer (e.g., quality-of-experience) measurements in a radio access network (RAN) when the UE's connection to the RAN is interrupted.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency 20) division duplexing (FDD), time division duplexing (TDD), or a combination thereof.

NG-RAN 199 is layered into a Radio Network Layer (RNL) and a Transport Network Layer (TNL). The NG-RAN logical nodes and interfaces between them are part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs are logical nodes that host higher-layer protocols and perform various gNB functions such controlling the operation of DUs, which are logical nodes that host lower-layer protocols and can include various subsets of the gNB functions. Each of the CUs and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Quality of Experience (QoE) measurements were specified for UEs operating in earlier-generation Long-Term Evolution (LTE) and UMTS networks, and are being specified for UEs operating in NR networks. All of these measurements operate according to similar high-level principles, with the purpose of measuring the end-user experience when running certain applications over the network. For example, QoE measurements for streaming services and for MTSI (Mobility Telephony Service for IMS) are supported in LTE.

Radio resource control (RRC) signaling is used by a RAN to configure application-layer measurements in UEs and to collect QoE measurement result files from configured UEs. In particular, an application-layer measurement configuration from a core network (e.g., LTE EPC, 5GC) or a network operations/administration/maintenance (OAM) function is encapsulated in a transparent container and sent to a UE's serving RAN node (e.g., eNB, gNB), which forwards it to a UE in an RRC message. Application-layer measurements made by the UE are encapsulated in a transparent container and sent to the serving RAN node in an RRC message. The serving RAN node then forwards the container to a Trace Collector Entity (TCE) or a Measurement Collection Entity (MCE) associated with the CN.

### SUMMARY

However, there are various problems, issues, and/or difficulties related to a UE's configured QoE measurements when the UE's RRC connection with a first RAN node (e.g., gNB or ng-eNB) is interrupted (e.g., by UE entering RRC_INACTIVE) and is later resumed or reestablished with a second RAN node.

Embodiments of the present disclosure provide specific improvements to QoE measurements by UEs in a wireless network, such as by providing, enabling, and/or facilitating solutions to exemplary problems summarized above and described in more detail below.

Embodiments include methods (e.g., procedures) for a UE configured for application-layer (e.g., QoE) measurements in a RAN.

These exemplary methods can include receiving one or more configurations of application-layer measurements to be performed by the UE while the UE is connected to the RAN. These exemplary methods can also include, in response to an interruption in the UE's connection to the RAN while the UE is configured to perform the application-layer measurements, sending one of the following requests to the RAN: a request to resume the UE's connection, or a request to reestablish the UE's connection. These exemplary methods can also include, in response to the request sent to the RAN, receiving from the RAN a command to setup a new connection to the RAN. These exemplary methods can also include, in response to the command, releasing the received configurations and discarding any stored application-layer measurement reports.

In some embodiments, receiving the command implicitly indicates that the UE should release the received configurations and discard any stored application-layer measurement reports.

In some embodiments, the interruption in the UE's connection to the RAN is based on the UE's connection being suspended to an inactive state (e.g., RRC_INACTIVE), and the request is a request to resume the UE's suspended connection.

In some embodiments, these exemplary methods can also include, for each of the received configurations, initiating a timer in response to one of the following: receiving the configuration, receiving the command, or sending to the RAN an application-layer measurement report associated with the configuration.

In some of these embodiments, these exemplary methods can also include the following operations after initiating a timer associated with a configuration:
maintaining any stored application-layer measurement reports associated with the configuration, until the earlier of the following: expiration of the timer, and connecting to the RAN via a RAN node that supports the configuration; and
releasing the configuration and discarding any stored application-layer measurement reports associated with the configuration, after expiration of the timer without connecting to the RAN via a RAN node that supports the configuration.

In some of these embodiments, these exemplary methods can also include, upon connecting to the RAN via a RAN node that supports the configuration, sending the following to the RAN node: any stored application-layer measurement reports associated with the configuration, and an identifier of an intended recipient MCE.

In some embodiments, the one or more configurations are received from a first RAN node, and the request is sent to and the command is received from a second RAN node. In other embodiments, the one or more configurations are received from, the request is sent to, and the command is received from a single RAN node.

Other embodiments include methods (e.g., procedures) for RAN node configured to manage application-layer (e.g., QoE) measurements by UEs in the RAN.

These exemplary methods can include receiving one of the following requests from a UE that was previously provided with one or more configurations of application-layer measurements to be performed by the UE while the UE is connected to the RAN: a request to resume the UE's connection to the RAN, or a request to reestablish the UE's connection to the RAN. These exemplary methods can also include, in response to the request from the UE, sending the UE a command to setup a new connection to the RAN, where the command implicitly indicates that the UE should release the one or more configurations previously provided to the UE and discard any stored application-layer measurement reports.

In some embodiments, these exemplary methods can also include determining one of the following in response to the request from the UE: a failure occurred during attempted retrieval of a UE context stored in the RAN, or at least a portion of the one or more configurations is undesirable for the RAN node. In such case, the command to setup the new connection is sent to the UE in response to the determination.

In some of these embodiments, the failure during attempted retrieval of the UE context is one of the following: the UE context is unavailable to be retrieved; or the RAN node is unable to interpret or understand some portion of the retrieved UE context.

In some of these embodiments, determining that at least a portion of the one or more configurations is undesirable for the RAN node comprises retrieving the UE context that includes the one or more configurations and determining one or more of the following based on the retrieved UE context:
the RAN node does not support one or more features associated with the at least a portion;
the RAN node does not have resources available to support the at least a portion; and
an area served by the RAN node is not within a measurement area associated with the at least a portion.

In some embodiments, the one or more configurations were provided to the UE by the RAN node, and these exemplary methods also includes deleting a UE context stored by the RAN node before receiving the request. In particular, the stored UE context includes the one or more configurations. In other embodiments, the one or more configurations were provided to the UE by a further RAN node.

Other embodiments include UEs (e.g., wireless devices, etc.) and RAN nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein can avoid and/or prevent misalignment between UE and RAN regarding application-layer (e.g., QoE) measurements when the UE does not successfully resume or reestablish an RRC connection with a RAN node for any of various reasons. By performing various operations with respect to affected measurement configurations, embodiments can reduce UE energy consumption relative to conventional techniques whereby a UE continues measurements upon receiving a connection setup message after a failed attempt to resume or reestablish an RRC connection.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 shows a signal flow diagram of a scenario in which an RRC_INACTIVE UE attempts to resume its connection in a cell served by a target gNB other than its last serving gNB.

FIGS. 5A and 5B show signal flow diagrams for successful and unsuccessful RRC connection re-establishment procedures, respectively.

FIGS. 6A-C illustrate various aspects of QoE measurement configuration for a UE in an LTE network.

FIGS. 7A-C illustrate various aspects of QoE measurement collection for a UE in an LTE network.

FIGS. 8-9 are diagrams of signaling between a UE, a first RAN node, and a second RAN node, according to various embodiments of the present disclosure.

FIG. 10 shows a flow diagram of an exemplary method (e.g., procedure) for a UE, according to various exemplary embodiments of the present disclosure.

FIG. 11 shows a flow diagram of an exemplary method (e.g., procedure) for a RAN node (e.g., base station, eNB, gNB, ng-eNB, etc.), according to various embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, at least one of which is wireless, according to various embodiments of the present disclosure.

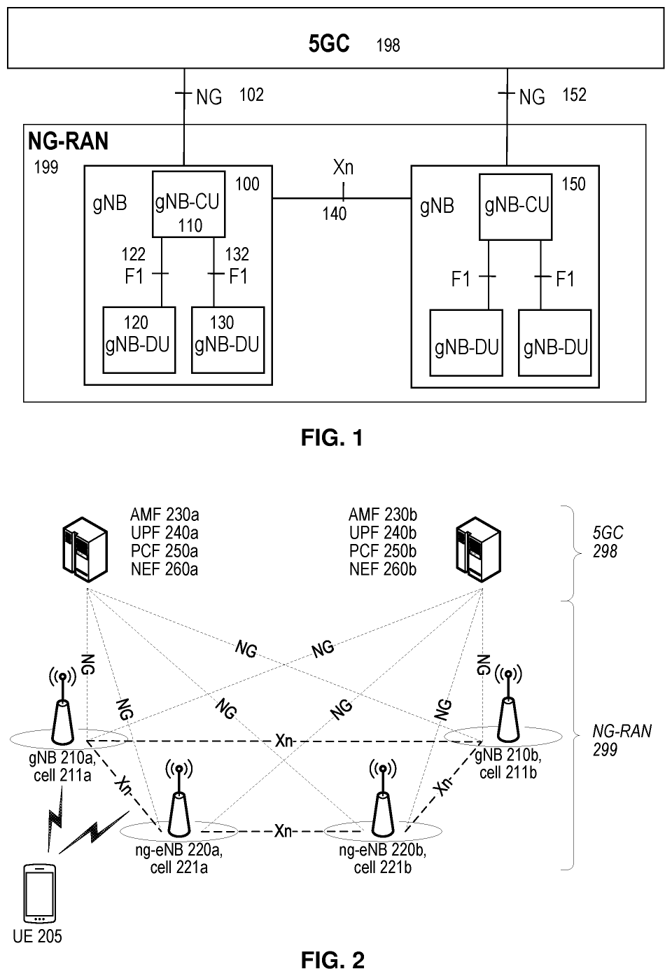

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP-specific or similar terminology is often used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows a high-level view of an exemplary 5G network architecture, including NG-RAN 299 and 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to 5GC, more specifically to the Access and Mobility Management Functions (AMFs, e.g., 230a,b) via respective NG-C interfaces and to User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) LTE radio interface. Unlike conventional LTE eNBs, however, ng-eNBs connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

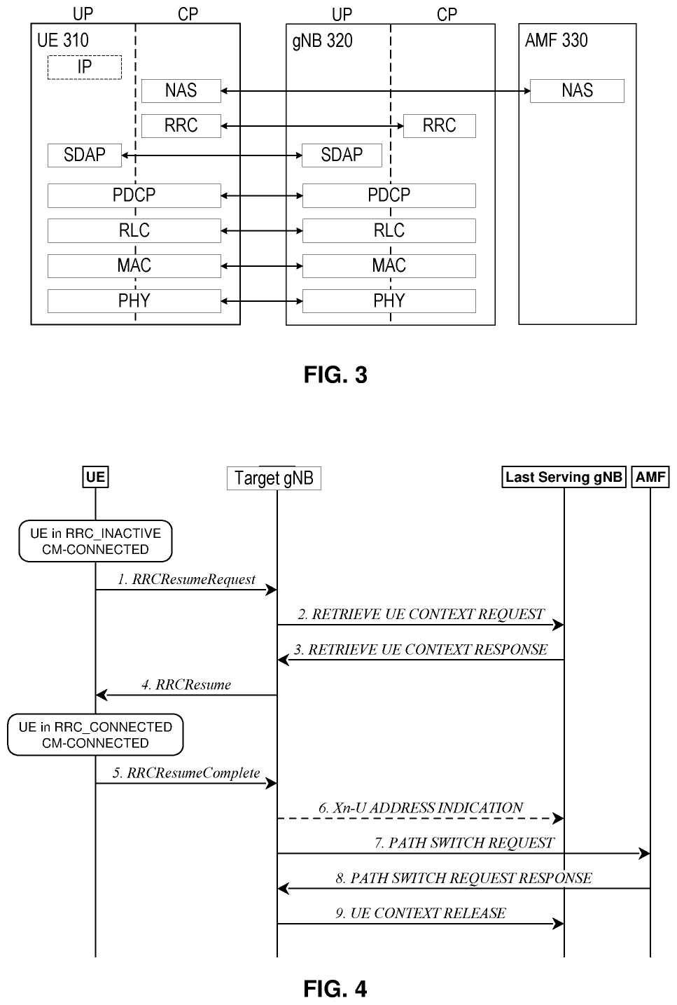

FIG. 3 shows an exemplary configuration of NR user plane (UP) or control plane (CP) protocol stacks between a UE (310), a gNB (320), and an AMF (330). Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission 15 for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping.

NR RRC also includes an RRC_INACTIVE state in which a UE is known (e.g., via UE context) by the serving gNB. More specifically, an RRC_INACTIVE UE remains in CM-CONNECTED (i.e., where the UE's CN resources are maintained) and can move within a RAN Notification Area (RNA) configured by NG-RAN without notifying the NG-RAN of changes in serving gNBs within the RNA. In RRC_INACTIVE, the last serving gNB node keeps the UE context and the UE-associated NG connection with the UE's serving AMF and UPF.

If the last serving gNB receives DL data for the UE from the UPF while the UE is in RRC_INACTIVE, it pages in the cells corresponding to the RNA and may send XnAP RAN Paging to neighbor gNB(s) if the RNA includes cells of neighbor gNB(s). The same paging takes place when the last serving gNB receives DL UE-associated signaling from the AMF, except a UE Context Release Command message. Upon receiving such a UE Context Release Command message for an RRC_INACTIVE UE, the last serving gNB may page in the cells corresponding to the RNA and may send XnAP RAN Paging to neighbor gNB(s) if the RNA includes cells of neighbor gNB(s), in order to release UE explicitly.

In general, the RNA configured for a UE can a single or multiple cells within the UE's CN registration area. There are several different alternatives on how the RNA can be configured. For example, a UE can be provided an explicit list of one or more cells that constitute the RNA. Alternately, the UE can be provided (at least one) RAN area ID, where a RAN area is a CN Tracking Area or a subset thereof. A RAN area is specified by one RAN area ID, which consists of a tracking area code (TAC) and optionally a RAN area code. Each cell can broadcast one or more RAN area IDs in its SI. The NG-RAN may provide different RNA definitions to different UEs but not one definition to each UE at any given time.

FIG. 4 shows a signal flow diagram of a scenario in which an RRC_INACTIVE UE attempts to resume (i.e., enter RRC_CONNECTED) in a cell served by a target gNB other than the last serving gNB, by transmitting an RR (ResumeRequest message to the target gNB. In this scenario, the target gNB triggers an XnAP Retrieve UE Context procedure to retrieve the UE context from the last serving gNB. Further details about the UE context retrieval procedure in FIG. 4 operations 2-3 can be found in 3GPP TS 38.300 (v16.6.0).

Upon successful UE context retrieval (operation 3), the target gNB performs a resume procedure by transmitting an RR (Resume message to the UE, which causes the UE to re-enter RRC_CONNECTED state (operation 4) and respond with an RROResumeComplete message (operation 5). The target gNB triggers an NGAP Path Switch Request (operation 7) and may also trigger an Xn-U Address Indication procedure (operation 6) including tunnel information for potential recovery of data from the last serving gNB. After the path switch procedure, the serving gNB triggers release of the UE context by the previous serving gNB, e.g., via a XnAP UE Context Release procedure (operation 9).

As an alternative to the messaging in FIG. 4, the target gNB can decide to reject RRCResumeRequest directly and keep the UE in RRC_INACTIVE without any reconfiguration or can decide to setup a new RRC connection. In either case, signaling radio bearer 0 (SRB0, without security) is used. Conversely, SRB1 (with integrity protection and ciphering as previously configured) is used whenever the gNB decides to reconfigure the UE (e.g., with new DRX cycle and/or RNA) or to send the UE to RRC_IDLE state.

An RRC_INACTIVE UE is required to initiate RNA update (RNAU) when it moves out of the configured RNA. When receiving an RNA update request from a UE, the receiving gNB triggers an XnAP Retrieve UE Context procedure to get the UE context from the last serving gNB. The receiving gNB may decide to send the UE back to RRC_INACTIVE state, move the UE into RRC_CONNECTED state, or send the UE to RRC_IDLE. In case of periodic RNA update, if the last serving gNB decides not to relocate the UE context, it fails the Retrieve UE Context procedure.

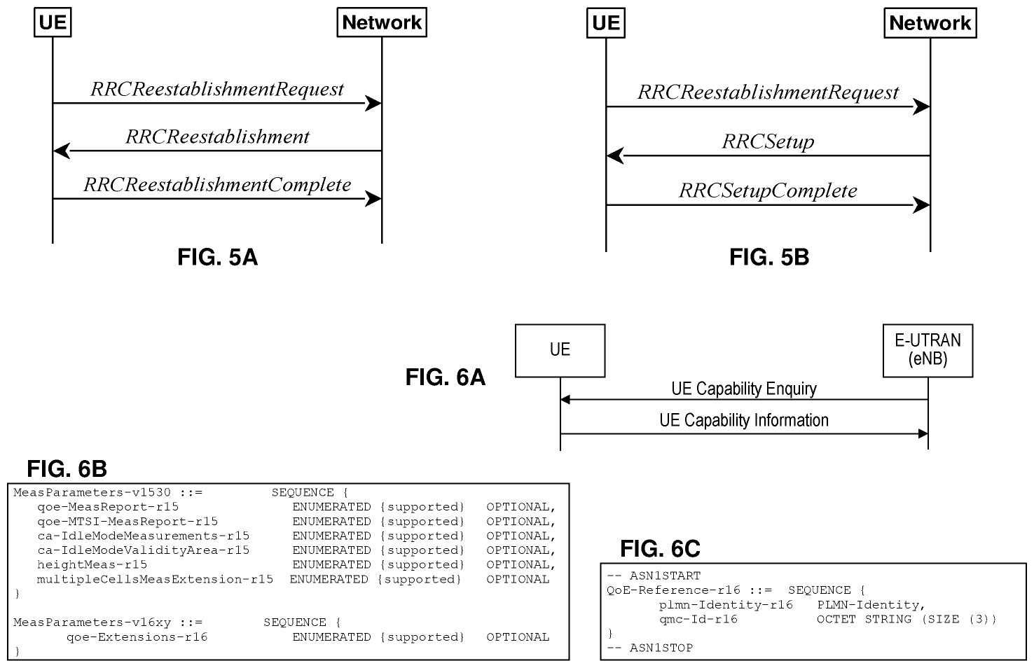

A target gNB may also need to fetch a UE context when the UE attempts RRC connection re-establishment. An RRC_CONNECTED UE may attempt connection re-establishment when access stratum (AS) security was previously activated with SRB2 and at least one DRB is setup. The connection re-establishment succeeds if the network can find and verify a valid UE context. FIG. 5A shows a signal flow diagram for a successful RRC connection re-establishment procedure. On the other hand, if the UE context cannot be retrieved, the network responds with an RRCSetup message according to 3GPP TS 38.331 (v16.4.1) section 5.3.3.4. FIG. 5B shows a signal flow diagram for an unsuccessful RRC connection re-establishment procedure with fallback to successful setup/establishment of a new RRC connection.

For example, the network can apply connection re-establishment under any of the following conditions or scenarios:
when AS security has been activated and the network retrieves or verifies the UE context:
to re-activate AS security without changing algorithms;
to re-establish and resume SRB1;
when UE is re-establishing an RRC connection, and the network is not able to retrieve or verify the UE context;
to discard the stored AS Context and release all RBs and BH RLC channels;
to fallback to establish a new RRC connection.

On the other hand, the UE shall not initiate re-establishment but instead release the connection and move to RRC_IDLE directly in the following scenarios:
when AS security has not been activated, with release cause ‘other’;
when AS security has been activated but SRB2 and at least one DRB are not setup, with release cause ‘RRC connection failure’.

As briefly mentioned above, QoE measurements have been specified for UEs operating in LTE networks and in earlier-generation UMTS networks. Measurements in both networks operate according to the same high-level principles. Their purpose is to measure the experience of end users when using certain applications over a network. For example, QoE measurements for streaming services and for MTSI (Mobility Telephony Service for IMS) are supported in LTE.

QoE measurements may be initiated towards the RAN from an OAM node generically for a group of UEs (e.g., all UEs meeting one or more criteria), or they may also be initiated from the CN to the RAN for a specific UE. The configuration of the measurement includes the measurement details, which is encapsulated in a container that is transparent to RAN.

A “TRACE START” S1AP message is used by the LTE EPC for initiating QoE measurements by a specific UE. This message carries details about the measurement configuration the application should collect in the “Container for application-layer measurement configuration” IE, which transparent to the RAN. This message also includes details needed to reach the TCE to which the measurements should be sent.

FIGS. 6A-C illustrate a procedure between an E-UTRAN and a UE for configuring QoE measurements in an LTE network. FIG. 6A shows an exemplary UE capability transfer procedure used to transfer UE radio access capability information from the UE to E-UTRAN. Initially, the E-UTRAN can send a UECapabilityEnquiry message. The UE can respond with a UECapabilityInformation message that includes a “UE-EUTRA-Capability” IE.

This IE may further include a UE-EUTRA-Capability-v1530 IE, which can be used to indicate whether the UE supports QoE Measurement Collection for streaming services and/or MTSI services. In particular, the UE-EUTRA-Capability-v1530 IE can include a measParameters-v1530 IE containing the information about the UE's measurement support. In some cases, the UE-EUTRA-Capability IE can also include a UE-EUTRA-Capability-v16xy-IE″, which can include a qoe-Extensions-r16 field. FIG. 6B shows an exemplary ASN.1 data structure for these various IEs, with the various fields defined in Table 1 below.

TABLE 1

| Field name | Description |
|---|---|
| qoe-MeasReport | Indicates whether the UE supports QoE |
| | Measurement Collection for streaming services. |
| qoe-MTSI-MeasReport | Indicates whether the UE supports QoE |
| | Measurement Collection for MTSI services. |
| qoe-Extensions | Indicates whether the UE supports the Rel-16 |
| | extensions for QoE Measurement Collection, i.e., |
| | support of more than one QoE measurement type |
| | at a time and signaling of withinArea, |
| | sessionRecordingIndication, qoe-Reference, |
| | temporaryStopQoE and restartQoE |
| temporaryStopQoE | Indicates that reporting, but not collection, |
| | of QoE measurements shall be temporarily |
| | stopped. |
| withinArea | Indicates at handover, for each application-layer |
| | measurement, whether the new cell is inside the |
| | area for the measurement, i.e., whether the UE is |
| | allowed to start new measurements in the cell |
| restartQoE | Indicates that QoE measurements can be reported |
| | again after a temporary stop. |

FIG. 6C shows an exemplary ASN.1 data structure for the qoe-Reference parameter mentioned in Table 4 above.

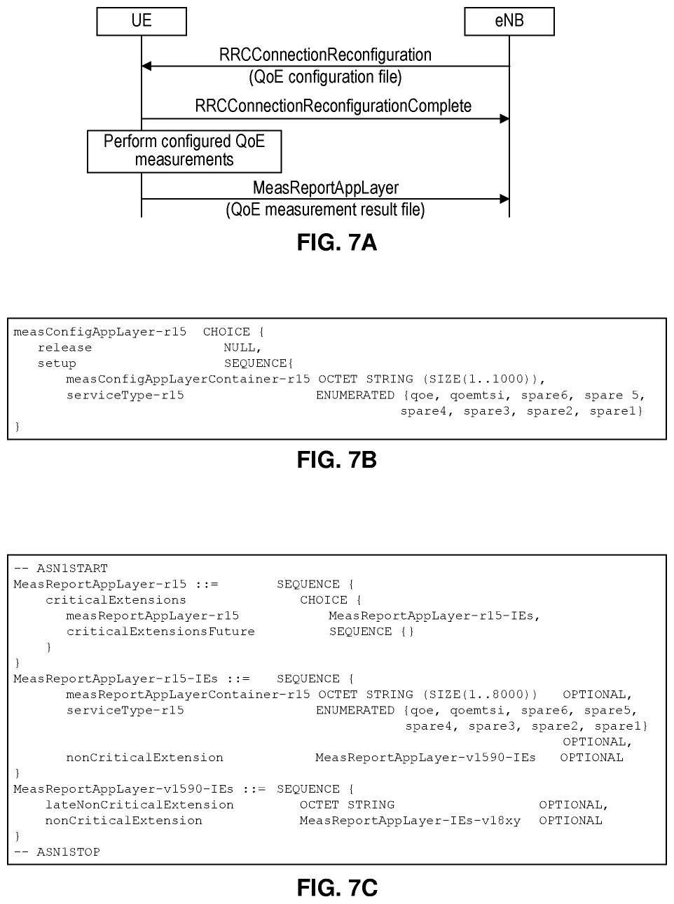

FIGS. 7A-C illustrate various aspects of QoE measurement collection for a UE in an LTE network. In particular, FIG. 7A shows an exemplary signal flow diagram of a QoE measurement collection process for LTE. To initiate QoE measurements, the serving eNB sends to a UE in RRC_CONNECTED state an RRCConnectionReconfiguration message that includes a QoE configuration file, e.g., a measConfigAppLayer IE within an OtherConfig IE. As discussed above, the QoE configuration file is an application-layer measurement configuration received by the eNB (e.g., from EPC) encapsulated in a transparent container, which is forwarded to UE in the RRC message. The UE responds with an RRCConnectionReconfigurationComplete message.

Subsequently, the UE performs the configured QoE measurements and sends a MeasReportAppLayer RRC message to the eNB, including a QoE measurement result file. Although not shown, the eNB can forward this result file transparently (e.g., to EPC). More specifically, if the UE has been configured with SRB4, the UE can:
set the measReportAppLayerContainer in the MeasReportAppLayer message to the value of the application layer measurement report information;
set the serviceType in the MeasReportAppLayer message to the type of the application layer measurement report information; and
submit the MeasReportAppLayer message to lower layers for transmission via SRB4.

FIG. 7B shows an exemplary ASN.1 data structure for a measConfigAppLayer IE. The setup includes the transparent container measConfigAppLayerContainer which specifies the QoE measurement configuration for the Application of interest. In the service Type field, a value of “qoe” indicates Quality of Experience Measurement Collection for streaming services and a value of “qoemtsi” indicates Enhanced Quality of Experience Measurement Collection for MTSI. This field also includes various spare values.

FIG. 7C shows an exemplary ASN.1 data structure for a measReportAppLayer IE, by which a UE can send to the E-UTRAN (e.g., via SRB4) the QoE measurement results of an application (or service). The service for which the report is being sent is indicated in the service Type IE.

Seamless mobility is a key feature of 3GPP radio access technologies (RATs). In general, a network configures a UE to perform and report radio resource management (RRM) measurements to assist network-controlled mobility decisions, such as for handover from a serving cell to a neighbor cell while the UE is in RRC_CONNECTED state. Seamless handovers ensure that the UE moves around in the coverage area of different cells without causing too many interruptions in data transmission.

During preparation for handover of a UE to a target node, the source node sends the current UE configuration to the target node in the HANDOVER REQUEST message. The target node prepares a target configuration for the UE based on the current configuration and the capabilities of the target node and the UE. The target node sends the target configuration to the source node in a HANDOVER REQUEST ACKNOWLEDGE message, which the source node encapsulates in an RRCReconfiguration message to the UE. As a streamlined option, the target configuration can be signaled as a “delta-configuration” including only the differences from the UE's current configuration in the source cell.

However, the target node may not recognize something in the UE's current configuration because it is a feature supported by the source node but not the target node. In such case the target node will trigger a full configuration, causing the UE to discard the current configuration and make a new configuration from scratch. This is referred to as “full configuration” or “full config” and is further described in 3GPP TS 38.331 (v16.4.1) section 5.3.5.11. Full configuration may also be used in the following cases:
when the network prefers to signal a full target configuration rather than a delta configuration with respect to the UE's current configuration; and
when the target node does not support QoE measurements, or does not support QoE measurements of a certain type supported and/or previously configured by the source node.

An RRC_INACTIVE UE that suspended its connection in a first cell controlled by a first RAN node (e.g., gNB) can attempt to resume its connection in a second cell controlled by a (different) second RAN node (e.g., gNB). If the second RAN node is able to retrieve the UE context but doesn't support QoE measurements, it will not recognize this part of the retrieved UE context and will trigger an RRC setup procedure of an RRC resume. The second RAN node can trigger an RRC setup procedure when the gNB decides not to configure QoE measurements for the UE, such as when the second RAN node's served area is not within the area scope of the QoE measurements.

There can be other reasons why the second RAN node triggers an RRC Setup rather than an RRC resume for the UE. For example, the procedure to retrieve the UE context could fail or cannot be attempted. Reasons for a retrieval failure could be that the UE context has been deleted at by the first RAN node, or that the first RAN node was unable to verify the retrieved UE context. Reasons for not attempting a UE context retrieval include connectivity between the first and second RAN nodes does not exist or is broken.

Even when the second RAN node cannot trigger, or refrains from triggering, QoE measurements by the UE in the second cell, the QoE measurements are not stopped in the current RRC setup procedure. As such, the QoE measurements will continue in the UE but not in on the network side and there will be a mismatch between the UE and network configurations.

In another scenario, the UE can be connected to a first cell served by a first RAN node and attempts RRC connection re-establishment (e.g., as described in 3GPP TS 38.331 (v16.4.1) section 5.3.7.2) in a second cell served by a second RAN node. The second RAN node may be unable to retrieve the UE context from the first RAN node, resulting in the same fallback procedure as described above-triggering an RRC setup procedure rather than an RRC resume.

In another scenario, the RRC_INACTIVE UE may attempt to resume or re-establish the RRC connection towards the first RAN node due to conditions in the first cell. However, the UE Context may have been deleted (e.g., to make room to other UEs in RRC_CONNECTED) but the UE has not be informed about it. Since the first RAN node is unable to recover the UE context, it will trigger an RRC setup towards the UE. This scenario may occur in race conditions where an RRC_INACTIVE UE attempts to resume about at the same time as when the first RAN node deletes the UE context, such that there is a mismatch between the UE's RRC state and/or context at the UE and at the network node.

Accordingly, embodiments of the present disclosure provide flexible and efficient techniques whereby a UE can clear and/or release existing QoE configurations when an RRC setup procedure is triggered by a RAN node, e.g., in response to an attempt to resume or to re-establish the RRC connection. These techniques can avoid and/or prevent a situation where the UE continues performing QoE measurements in a cell served by a RAN node that doesn't support QoE measurements, or when the RAN node does not configure some or all of the previously configured QoE measurements.

Embodiments can be summarized at a high level as follows. A UE performing a connection resume procedure with a network node can send a resume request message to the network node, which can respond to the UE with a connection setup message (e.g., to setup a new connection to the network). For example, these messages can be sent/received by a radio layer (e.g., RRC) of the UE. Based on receiving the connection setup message, the UE can clear and/or release one or more QoE configurations existing at the UE (e.g., in UE application layer).

Similarly, a UE performing a connection reestablishment procedure with a network node can send a connection reestablishment request to the network node, which can respond to the UE with a connection setup message. For example, these messages can be sent/received by a radio layer (e.g., RRC) of the UE. Based on receiving the connection setup message, the UE can clear and/or release one or more QoE configurations existing at the UE (e.g., in UE application layer).

In this manner, embodiments avoid and/or prevent misalignment between UE and network regarding QoE measurements when the UE does not successfully resume or reestablish an RRC connection with a network node for any of various reasons. By clearing and/or releasing existing QoE configurations, embodiments can reduce UE energy consumption relative to conventional techniques whereby a UE continues QoE measurements upon receiving a connection setup message.

In the following description of embodiments, the following groups of terms and/or abbreviations have the same or substantially similar meanings and, as such, are used interchangeably and/or synonymously unless specifically noted or unless a different meaning is clear from a specific context of use:
“application layer” and “UE application layer” (RAN nodes generally do not have an application layer);
“application-layer measurement”, “application measurement”, and “QoE measurement”;
“QoE measurement report”, “QoE report”, “measurement report”, and “report”;
“QoE measurement configuration”, “QoE configuration”, “measurement configuration”;
“modem”, “radio layer”, “radio network layer”, and “access stratum”;
“radio layer connection” and “RRC connection”
“service” and “application”;
“measurement collection entity”, “MCE”, “trace collection entity”, and “TCE”.

Although embodiments are described in the context of a UE receiving a connection setup message (e.g., RRCSetup), embodiments are also applicable to cases where the UE receives other messages in response to sending a request to resume or to reestablish a connection.

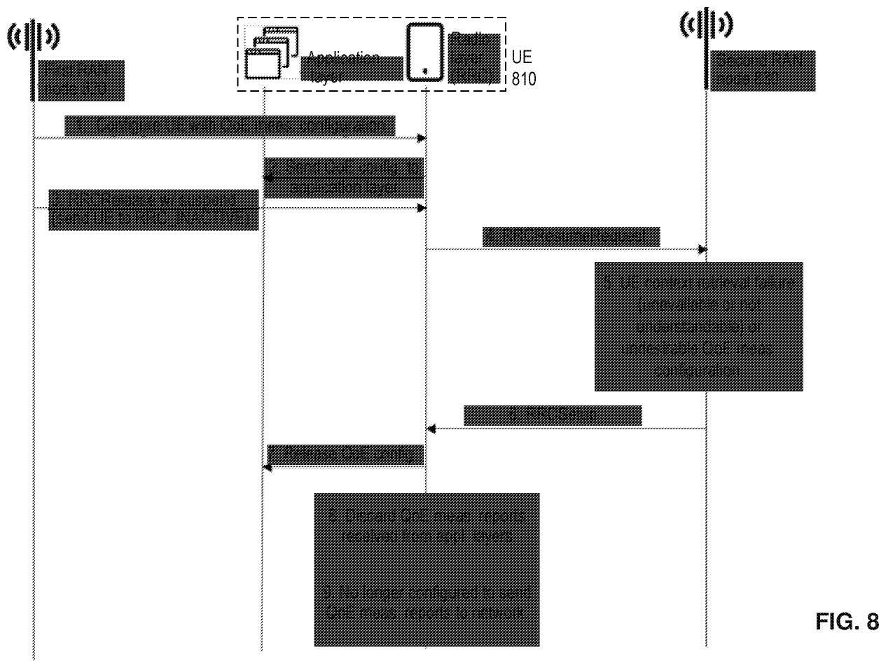

FIG. 8 shows a signaling diagram between a UE (810), a first RAN node (820), and a second RAN node (830) according to some embodiments of the present disclosure. Although FIG. 8 shows operations with numerical labels, the numbers are intended to facilitate the following description rather than to require and/or imply any particular order of the operations, unless expressly stated to the contrary.

In operation 1, the first RAN node configures the UE with a QoE measurement configuration via the radio-layer (e.g., RRC) connection with the UE. The first RAN node also arranges itself to receive subsequent QoE measurement reports from UE application layer via the RRC connection with the UE. In operation 2, the UE radio layer sends the QoE configuration to the UE application layer, which then can be considered as configured to perform QoE measurements according to the received configuration.

In operation 3, the first RAN node suspends the UE's RRC connection to RRC_INACTIVE state. This can be done, for example, by sending the UE an RRCRelease message including a suspend indication. Subsequently, after some amount of time, the UE performs cell reselection and finds a second cell associated with a second RAN node. In operation 4, the UE sends an RRCResume-Request message to the second RAN node. In operation 5, there is a UE context retrieval failure. For example, the second RAN node is unable to retrieve the UE's context from the first RAN node (e.g., for any of the reasons discussed above), or the second RAN node is able to retrieve the UE context but is unable to understand and/or correctly interpret the retrieved context.

Alternately, the QoE measurement configuration in the retrieved UE context may be undesirable to the second RAN node for some reason, such that the second RAN node does not support (e.g., optional parameters) or does not want the UE to continue all previously configured QoE measurements identified in the UE context. Alternately, the second RAN node may not have the necessary resources to support the previously configured QoE measurements. Alternately, the second RAN node (and/or the second cell) may not be within the relevant area for the previously configured QoE measurements.

Based on the outcome of operation 5, the second RAN node sends the UE a connection setup message (e.g., RR (′Setup) in operation 4 responsive to the RRCResumeRequest received from the UE in operation 6. In various embodiments, the RRCSetup may contain or indicate all, some, or none of the QoE measurement configuration(s) provided by the first RAN node to the UE. The previously provided QoE measurement configurations that are not contained in or indicated by the RRCSetup message will be referred to as “affected QoE configurations.” For example, if the RRCSetup message does not include any of the previously provided QoE measurement configurations, then this implicitly indicates that all previously received QoE measurement configurations are affected QoE configurations and that the UE should act accordingly on them.

In operation 7, upon receiving RRCSetup in response to the RRC ResumeRequest, the UE radio layer releases the affected QoE configurations or causes the application layer to release the affected QoE configurations. Alternatively or additionally, upon receiving RRC Setup in response to the RRCResumeRequest, in operation 8 the UE radio layer discards any stored QoE measurement reports associated with the affected QoE configurations, and/or discards any QoE measurement reports associated with the affected QoE configurations that are subsequently received from the UE application layer. Upon receiving RRCSetup in response to the RRCResumeRequest, in operation 9 the UE considers itself not to be configured to send any QoE measurement reports to the network, or not any QoE measurement reports associated with the affected QoE configurations.

In some embodiments, the affected QoE configurations can be identified by QoE configuration IDs stored at the UE, e.g., measConfigAppLayerID values stored in VarMeasConfigAppLayer. The UE can perform operations 7, 8, and/or 9 based on these identifiers, thereby avoiding mismatch between the UE and the network regarding the QoE configurations.

In a variant, the UE can continue configured QoE measurements and store possible QoE reports, but refrain from sending these until it later enters a cell (e.g., served by the first RAN node or a third RAN node) in which the QoE measurement configuration is supported. To support this behavior, the MCE address could be propagated to the UE together with the QoE measurement configuration, and the UE would send this address together with the stored QoE report when it enters a cell that supports such reporting-even if the RAN node serving that cell cannot obtain and/or understand the QoE configuration information in the UE's context. This can be the case after the UE has received an RRCSetup message as described above. Based on receiving this MCE address from the UE together with the QoE report, the RAN node will be able to forward the QoE report to the correct MCE, even without having any QoE configuration in the UE's context.

In another variant, to ensure that the configured QoE measurement area scope is not violated, the UE stops or pauses (i.e., refrains from initiating any new) measurements of the affected QoE configurations after reception of an RRCSetup message, but maintains stored reports of the affected QoE configurations until it later enters a cell (e.g., served by the first RAN node or a third RAN node) in which the affected QoE configurations are supported. Alternatively, the area scope could also be sent to the UE together with the QoE configuration, so that the UE itself can keep track of whether it is inside or outside the configured area scope.

Since the RAN node that later receives the QoE report does not have any QoE configuration in the stored UE context, it does not know how to map an RRC ID provided by the UE to the QoE reference ID provided by the MCE. To address this potential issue, the UE can send the QoE reference ID instead of the RRC ID when it sends a QoE report to a RAN node that does not have the relevant QoE configuration UE context stored for that UE.

In another variant, a timer may be associated with each QoE configuration in the UE. Expiration of the timer will trigger the UE to release the associated QoE configuration (e.g., FIG. 8 operation 7) and/or discard any stored QoE reports related to the associated QoE configuration (e.g., FIG. 8 operation 8). The timer can be configured together with the QoE configuration, or could be pre-configured/specified. The UE can initiate the timer upon receiving the QoE configuration, upon sending a QoE report according to the QoE configuration, or upon receiving the RRCSetup message. The UE can maintain the QoE configuration and associated stored QoE reports while the associated timer is running, in hopes of connecting to a RAN node that supports the QoE configuration before the timer expires.

There can be various reasons why the affected QoE configurations do not include all existing QoE measurement configurations at the UE. For example, the second RAN node may not want certain measurements to continue due to, e.g., a lack of supporting resources, a lack of support for associated service type(s), service subtype(s), S-NSSAI(s), etc. As another example, when the second RAN node contacts the AMF in 5GC to establish the NGAP relation (i.e., UE-associated logical NG-connection) and the UE context, the AMF may realize that this UE was previously selected for signaling-based QoE measurement configuration and may then choose to repeat this QoE measurement configuration.

To support this as early as possible, and to ensure that the UE does not discard previously recorded (but not yet reported) QoE data, the NGAP Initial Context Setup Request message can be augmented to support transfer of QoE measurement configuration information. This could be done by extending the existing Trace Activation IE with optional QoE measurement configuration information, or by introducing a new IE for this purpose in the Initial Context Setup Request NGAP message. An additional option to support this mechanism is that the second RAN node indicates in the NGAP Initial UE Message that the reason for this connection setup procedure is that the second RAN node failed to retrieve the UE's context from the first RAN node. This is an indication to the AMF that it may have previously stored UE context for this UE.

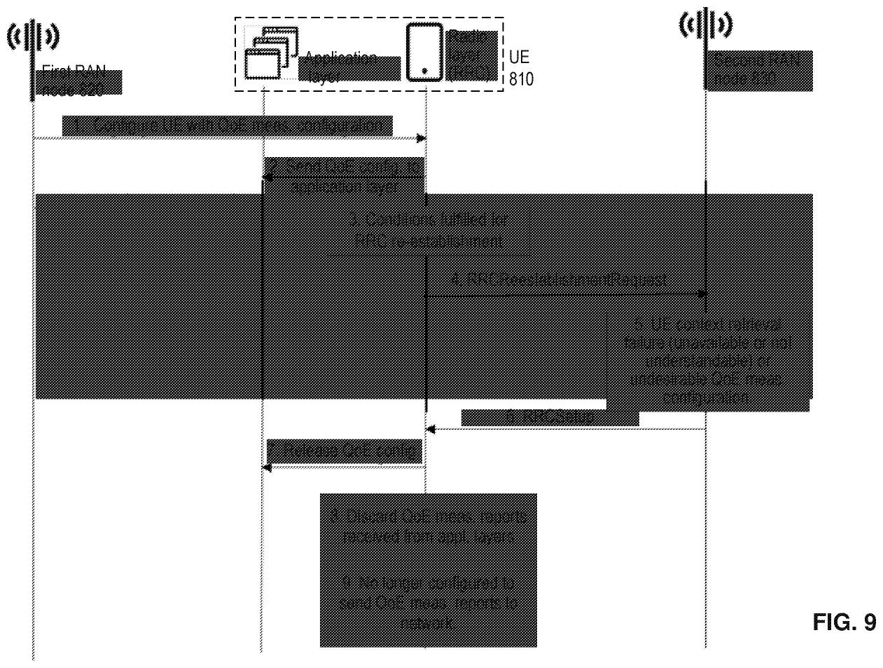

As mentioned above, the second RAN node can also trigger a connection setup procedure in response to a UE's connection reestablishment that has failed for any of various reasons. FIG. 9 shows a signaling diagram between a UE (810), a first RAN node (820), and a second RAN node (830) according to these embodiments of the present disclosure. The UE and RAN nodes shown in FIG. 9 can be substantially identical to identically numbered ones shown in FIG. 8. Although FIG. 9 shows operations with numerical labels, the numbers are intended to facilitate explanation rather than to require and/or imply any particular order of the operations, unless expressly stated to the contrary.

For brevity, descriptions will be omitted for operations in FIG. 9 that are substantially identical to operations described above in relation to FIG. 8. In operation 3, certain conditions are fulfilled in the UE radio layer for RRC connection reestablishment. This can include when AS security was previously activated with SRB2 and at least one DRB is setup. In operation 4, the UE sends an RRC ReestablishmentRequest message to the second RAN node. In operation 5, there is a UE context retrieval failure (e.g., for any of the reasons discussed above) or the QoE measurement configuration in the retrieved UE context may be undesirable to the second RAN node (e.g., for any of the reasons discussed above). Operations 6-9 proceed in the same manner as described above with respect to FIG. 8. Variants described above with respect to FIG. 8 are equally applicable to the embodiments illustrated by FIG. 9.

Although FIGS. 8-9 illustrate embodiments involving first and second RAN nodes, underlying principles are equally applicable to some embodiments involving a single RAN node. For example, an RRC_INACTIVE UE may attempt to resume or re-establish an RRC connection towards a first RAN node due to conditions in a first cell. However, the first RAN node may have deleted its stored UE context (e.g., to make room to other UEs in RRC_CONNECTED) but has not yet informed the UE, which continues to maintain its stored context towards the first RAN node.

Since the first RAN node is unable to recover the UE context, it will send an RRCSetup message to the UE. This scenario may occur in race conditions where an RRC_INACTIVE UE attempts to resume about at the same time as when the first RAN node deletes the UE context, such that there is a mismatch between the UE's RRC state and/or context at the UE and at the network node. This can cause the first RAN node to send an RRCSetup message to the UE, which can responsively perform the operations described above (e.g., operations 7-9 in FIGS. 8-9).

Various embodiments described above can be specified in a 3GPP specification. The following text shows an example specification of certain embodiments in 3GPP TS 38.331, using existing section numbers of that document.

### ***Begin Proposed 3GPP TS 38.331 Text***

### 5.3.3.4 Reception of the RRCSetup by the UE

The UE shall perform the following actions upon reception of the RRCSetup:
1> if the RRCSetup is received in response to an RRCReestablishmentRequest; or
1> if the RRCSetup is received in response to an RRCResumeRequest or RRCResumeRequest1:
   2> discard any stored UE Inactive AS context and suspendConfig;
   2> for the affected QoE configurations, inform upper layers to clear the stored application layer measurement configuration if any;
   2> for the affected QoE configurations, discard received application layer measurement report information from upper layers;
   2> consider itself not to be configured to send application layer measurement report for the affected QoE configurations;

### ***End Proposed 3GPP TS 38.331 Text***

The following text shows an example specification of other embodiments in 3GPP TS 38.331, using existing section numbers of that document. In these embodiments, the UE performs operations described above based on existing QoE configuration IDs (e.g., measConfigAppLayerID) in the VarMeasConfigAppLayer.

### ***Begin Proposed 3GPP TS 38.331 Text***

### 5.3.3.4 Reception of the RRCSetup by the UE

The UE shall perform the following actions upon reception of the RRCSetup:
1> if the RRCSetup is received in response to an RRCReestablishmentRequest; or
1> if the RRCSetup is received in response to an RRCResumeRequest or RRCResumeRequest1:
   2> discard any stored UE Inactive AS context and suspendConfig;
   2> for each measConfigAppLayerID in VarMeasConfigAppLayer pertaining to the affected QoE configurations:
      3> inform upper layers to clear the stored application layer measurement configuration;
      3> discard received application layer measurement report information from upper layers;
      3> consider itself not to be configured to send application layer measurement report;

### ***End Proposed 3GPP TS 38.331 Text:***

The following text shows an example specification of other embodiments in 3GPP TS 38.331, using existing section numbers of that document. In these embodiments, the UE performs operations described above in relation to FIG. 9 (reestablishment) based on existing QoE configuration IDs (e.g., measConfigAppLayerID)) in the VarMeasConfigAppLayer.

### ***Begin Proposed 3GPP TS 38.331 Text***

### 5.3.3.4 Reception of the RRCSetup by the UE

The UE shall perform the following actions upon reception of the RRCSetup:
1> if the RRCSetup is received in response to an RRCReestablishmentRequest;
   2> if Timer_for_QoE_Configuration_retention is expired then
      3> for the affected QoE configurations, inform upper layers to clear the stored application layer measurement configuration if any;
      3> for the affected QoE configurations, discard received application layer measurement report information from upper layers;
      3> consider itself not to be configured to send application layer measurement report for the affected QoE configurations;
or
1> if the RRCSetup is received in response to an RRCResumeRequest or RRCResume Request1:
   2> discard any stored UE Inactive AS context and suspendConfig;

### ***End Proposed 3GPP TS 38.331 Text***

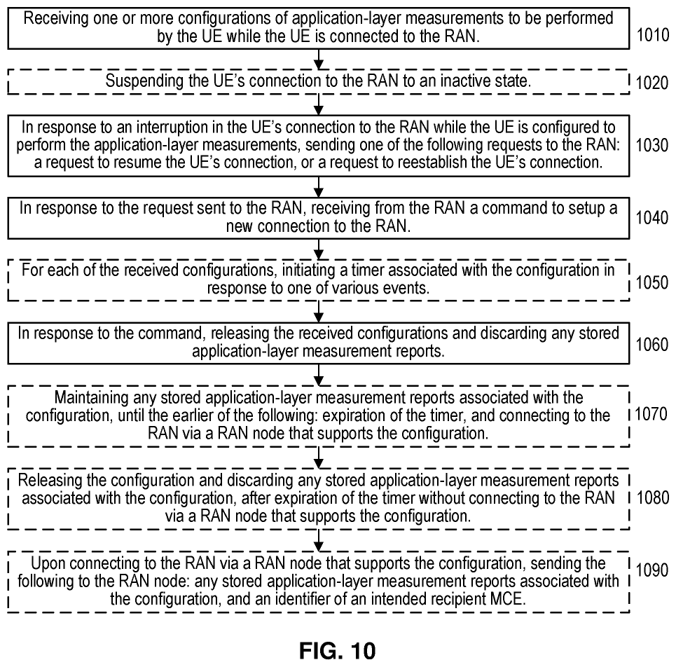

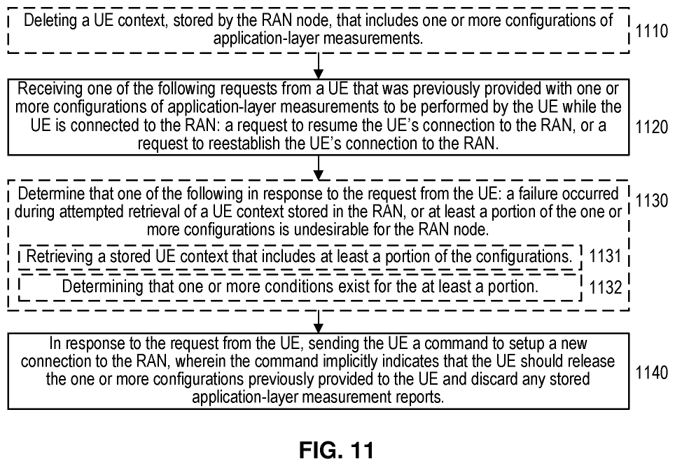

Various features of the embodiments described above correspond to various operations illustrated in FIGS. 10-11, which show exemplary methods (e.g., procedures) for a UE and a RAN node, respectively. In other words, various features of the operations described below correspond to various embodiments described above. Furthermore, the exemplary methods shown in FIGS. 10-11 can be used cooperatively to provide various benefits, advantages, and/or solutions to problems described herein. Although FIGS. 10-11 show specific blocks in particular orders, the operations of the exemplary methods can be performed in different orders than shown and can be combined and/or divided into blocks having different functionality than shown. Optional blocks or operations are indicated by dashed lines.

In particular, FIG. 10 shows an exemplary method (e.g., procedure) for a UE configured for application-layer measurements in a RAN, according to various embodiments of the present disclosure. The exemplary method can be performed by a UE (e.g., wireless device, etc.) such as described elsewhere herein.

The exemplary method can include the operations of block 1010, where the UE can receive one or more configurations of application-layer measurements to be performed by the UE while the UE is connected to the RAN. For example, the application-layer measurements can be QoE measurements. The exemplary method can also include the operations of block 1030, where in response to an interruption in the UE's connection to the RAN while the UE is configured to perform the application-layer measurements, the UE can send one of the following requests to the RAN: a request to resume the UE's connection, or a request to reestablish the UE's connection. The exemplary method can also include the operations of block 1040, where in response to the request sent to the RAN (e.g., in block 1030), the UE can receive from the RAN a command to setup a new connection to the RAN. The exemplary method can also include the operations of block 1060, where in response to the command, the UE can perform one or more operations with respect to the received configurations, such as releasing the received configurations and discarding any stored application-layer measurement reports.

In some embodiments, receiving the command (e.g., in block 1040) implicitly indicates that the UE should release the received configurations and discard any stored application-layer measurement reports. In other words, as discussed above, receiving the command implicitly indicates that all of the previously received configurations are “affected configurations”, and that the UE should release and discard accordingly.

In some embodiments, the interruption in the UE's connection to the RAN is based on the UE's connection being suspended to an inactive state (e.g., RRC_INACTIVE), and the request is a request to resume the UE's suspended connection.

In some embodiments, the exemplary method can also include the operations of block 1050, where for each of the received configurations, the UE can initiate a timer in response to one of the following: receiving the configuration (e.g., in block 1010), receiving the command (e.g., in block 1040), or sending to the RAN an application-layer measurement report associated with the configuration.

In some of these embodiments, the exemplary method can also include the following operations after initiating a timer associated with a configuration (e.g., in block 1050), labelled with corresponding block numbers:
(1070) maintaining any stored application-layer measurement reports associated with the configuration, until the earlier of the following: expiration of the timer, and connecting to the RAN via a RAN node that supports the configuration; and
(1080) releasing the configuration and discarding any stored application-layer measurement reports associated with the configuration, after expiration of the timer without connecting to the RAN via a RAN node that supports the configuration.

In some of these embodiments, the exemplary method can also include the operations of block 1090, where upon connecting to the RAN via a RAN node that supports the configuration, the UE can send the following to the RAN node: any stored application-layer measurement reports associated with the configuration, and an identifier of an intended recipient measurement collection entity (MCE).

In some embodiments, the one or more configurations are received from a first RAN node, and the request is sent to and the command is received from a second RAN node. Examples of these embodiments are shown in FIGS. 8-9. In other embodiments, the one or more configurations are received from, the request is sent to, and the command is received from a single RAN node.

In addition, FIG. 11 shows an exemplary method (e.g., procedure) for a RAN node configured to manage application-layer measurements by UEs, according to various embodiments of the present disclosure. The exemplary method can be performed by a RAN node (e.g., base station, eNB, gNB, ng-eNB, TRP, etc.) such as described elsewhere herein.

The exemplary method can include the operations of block 1120, where the RAN node can receive one of the following requests from a UE that was previously provided with one or more configurations of application-layer measurements to be performed by the UE while the UE is connected to the RAN: a request to resume the UE's connection to the RAN, or a request to reestablish the UE's connection to the RAN. For example, the application-layer measurements can be QoE measurements. The exemplary method can also include the operations of block 1140, where in response to the request from the UE, the RAN node can send the UE a command to setup a new connection to the RAN, where the command implicitly indicates that the UE should release the one or more configurations previously provided to the UE and discard any stored application-layer measurement reports.

In some embodiments, the exemplary method can also include the operations of block 1130, where the RAN node can determine one of the following in response to the request from the UE: a failure occurred during attempted retrieval of a UE context stored in the RAN, or at least a portion of the one or more configurations is undesirable for the RAN node. In such case, the command to setup the new connection is sent to the UE (e.g., in block 1140) in response to the determination of block 1130.

In some of these embodiments, the failure during attempted retrieval of the UE context is one of the following: the UE context is unavailable to be retrieved; or the RAN node is unable to interpret or understand some portion of the retrieved UE context.

In some of these embodiments, determining that at least a portion of the one or more configurations is undesirable for the RAN node (e.g., in block 1130) comprises retrieving the UE context that includes the one or more configurations (e.g., in sub-block 1131) and determining one or more of the following based on the retrieved UE context (e.g., in sub-block 1132):
the RAN node does not support one or more features associated with the at least a portion;
the RAN node does not have resources available to support the at least a portion; and
an area served by the RAN node is not within a measurement area associated with the at least a portion.

In some embodiments, the one or more configurations were provided to the UE by the RAN node, and the exemplary method also includes the operations of block 1110, where the RAN node can delete a UE context stored by the RAN node before receiving the request (e.g., in block 1120). In particular, the stored UE context includes the one or more configurations. In other embodiments, the one or more configurations were provided to the UE by a further RAN node (e.g., before the request in block 1120).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

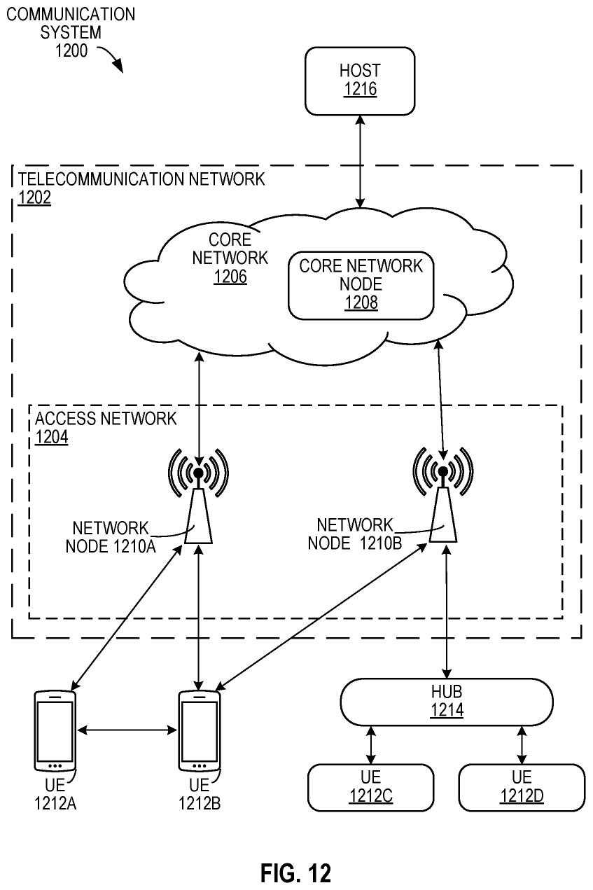

FIG. 12 shows an example of a communication system 1200 in accordance with some embodiments. In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends 25 commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

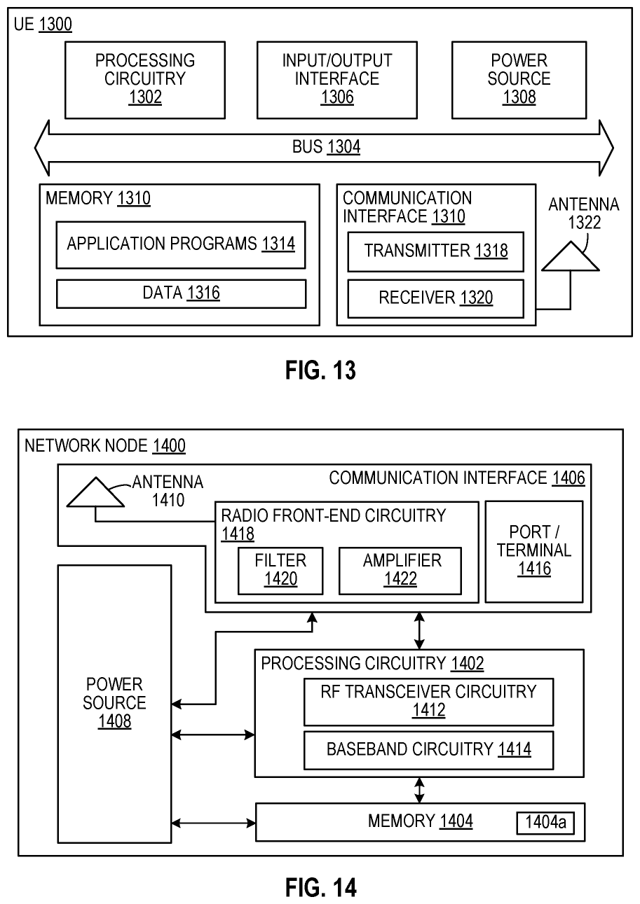

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions (collectively denoted computer program product 1404a) capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

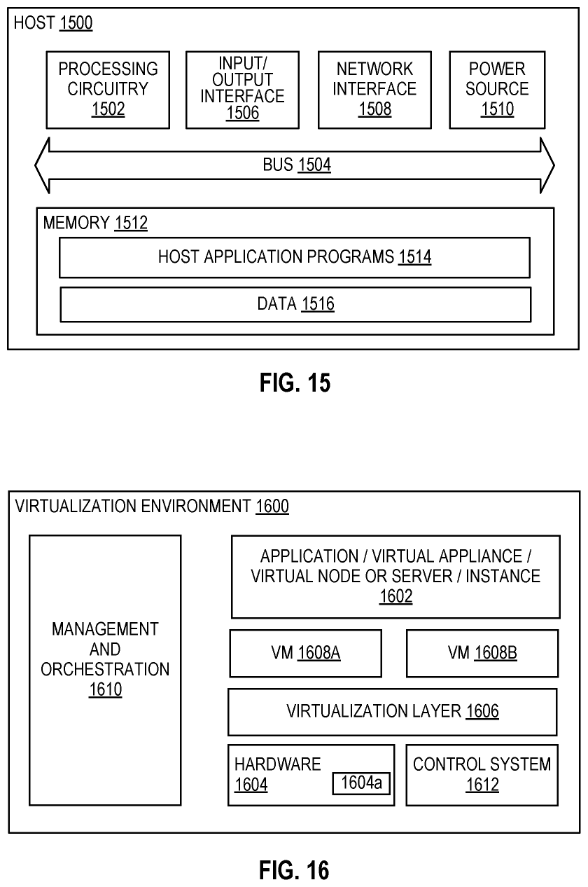

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions (collectively denoted computer program product 1604a) executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

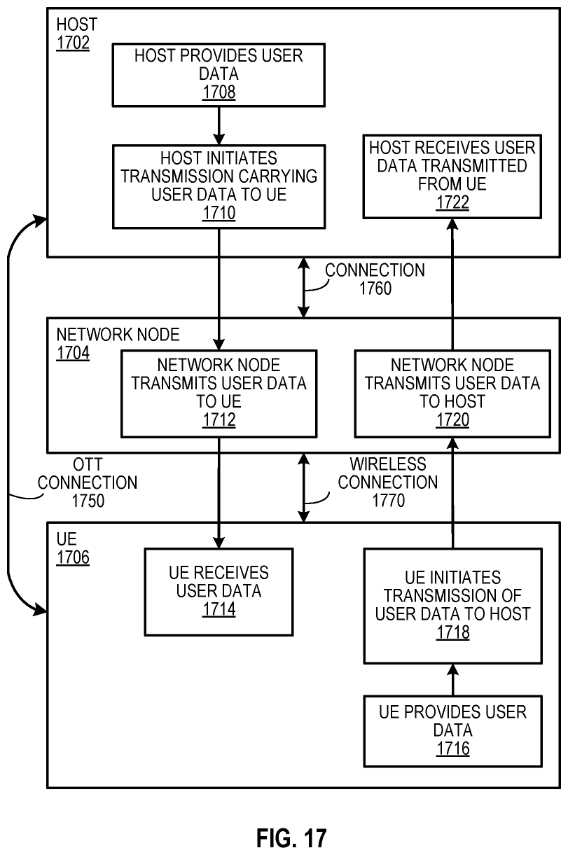

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, these embodiments provide flexible and efficient techniques that can avoid and/or prevent misalignment between UE and network regarding application-layer (e.g., QoE) measurements when the UE does not successfully resume or reestablish an RRC connection with a network node for any of various reasons. By performing various operations with respect to affected measurement configurations, embodiments can also reduce UE energy consumption relative to conventional techniques whereby a UE continues measurements upon receiving a connection setup message after a failed attempt to resume or reestablish an RRC connection. By improving the performance and reporting of application-layer measurements in this manner, embodiments facilitate improved network performance as experienced by applications, including OTT services. These improvements increase the value of such OTT services to end users and service providers.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results.

The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:
A1. A method for a user equipment (UE) configured for application-layer measurements in a radio access network (RAN), the method comprising:
   receiving one or more configurations of application-layer measurements to be performed by the UE while the UE is connected to the RAN;
   in response to an interruption in the UE's connection to the RAN before completing the application-layer measurements, sending one of the following requests to the RAN: a request to resume the UE's connection, or a request to reestablish the UE's connection;
   in response to the request, receiving from the RAN a command to setup a new connection to the RAN; and
   in response to the command, performing one or more one or more operations with respect to an affected portion of the one or more configurations.
A2. The method of embodiment A1, wherein the one or more operations include any of the following:
   releasing the affected portion;
   maintaining the affected portion;
   discarding any stored application-layer measurement reports associated with the affected portion;
   maintaining any stored application-layer measurement reports associated with the affected portion;
   stopping or pausing application-layer measurements based on the affected portion;
   continuing application-layer measurements based on the affected portion; and
   refraining from reporting the continued application-layer measurements to the RAN.
A3. The method of embodiment A2, wherein in response to the command, the UE maintains the affected portion, maintains any stored application-layer measurement reports associated with the affected portion, and stops or pauses the application-layer measurements based on the affected portion.
A4. The method of any of embodiments A2-A3, further comprising initiating a timer in response to one of the following: receiving the affected portion of the configurations, receiving the command, or sending a measurement report associated with the affected portion.
A5. The method of embodiment A4, wherein:
   the one or more stored application-layer measurement reports associated with the affected portion are maintained until the earlier of expiration of the timer and the UE connecting to the RAN via a RAN node that supports the affected portion;
   and the one or more stored application-layer measurement reports are discarded after expiration of the timer without the UE connecting to the RAN via a RAN node that supports the affected portion.
A6. The method of embodiment A5, further comprising, upon connecting to the RAN via a RAN node that supports the affected portion, sending the one or more stored application-layer measurement reports together with an identifier of an intended recipient measurement collection entity (MCE).
A7. The method of any of embodiments A1-A6, wherein the received configurations are identified by respective identifiers, and the command includes the identifiers corresponding to the affected portion.
A8. The method of any of embodiments A1-A6, wherein receiving the command implicitly indicates that the affected portion includes all of the received configurations.
A9. The method of any of embodiments A1-A8, wherein one of the following applies:
   the one or more configurations are received from a first RAN node, and the request is sent to and the command is received from a second RAN node; or
   the one or more configurations are received from, the request is sent to, and the command is received from a single RAN node.
A10. The method of any of embodiments A1-A9, wherein the application-layer measurements are quality-of-experience (QoE) measurements.
A11. The method of any of embodiments A1-A10, wherein the interruption in the UE's connection to the RAN is based on suspending the UE's connection to an inactive state, and the request is a request to resume the UE's suspended connection.
B1. A method for a radio access network (RAN) node configured to manage application-layer measurements by user equipment (UEs) in the RAN, the method comprising:
   receiving one of the following requests from a UE that was previously provided with one or more configurations of application-layer measurements to be performed by the UE while the UE is connected to the RAN:
      a request to resume the UE's connection to the RAN, or
      a request to reestablish the UE's connection to the RAN;
   in response to the request, determining that one of the following occurred:
      a failure during attempted retrieval of a UE context stored in the RAN, or
      an affected portion of the one or more configurations is undesirable for the RAN node; and
   in response to the determination, sending the UE a command to setup a new connection to the RAN.
B2. The method of embodiment B1, wherein the failure during attempted retrieval of the UE context is one of the following:
   the UE context is unavailable to be retrieved; or
   the RAN node is unable to interpret or understand some portion of the retrieved UE context.
B3. The method of any of embodiments B1-B2, wherein determining that an affected portion of the one or more configurations is undesirable for the RAN node is based on retrieving the UE context that includes the one or more configurations and determining one or more of the following:
   the RAN node does not support one or more features associated with the affected portion;
   the RAN node does not have resources available to support the affected portion; and
   an area served by the RAN node is not within a measurement area associated with the affected portion.
B4. The method of any of embodiments B1-B3, wherein the retrieved UE context includes respective identifiers of the one or more configurations.
B5. The method of embodiment B4, wherein one of the following applies:
   the command includes the identifiers corresponding to the affected portion; or
   the command implicitly indicates that the affected portion includes all of the received configurations.
B6. The method of any of embodiments B1-B5, wherein the one or more configurations were provided to the UE by the RAN node, and the method further comprises deleting the stored UE context including the one or more configurations before receiving the request.
B7. The method of any of embodiments B1-B5, wherein the one or more configurations were provided to the UE by a further RAN node.
B8. The method of any of embodiments B1-B7, wherein the application-layer measurements are quality-of-experience (QoE) measurements.
C1. A user equipment (UE) configured for application-layer measurements in a radio access network (RAN), the UE comprising:
   communication interface circuitry configured to communicate with one or more RAN nodes; and
   processing circuitry operatively coupled to the radio transceiver circuitry, whereby the processing circuitry and the radio transceiver circuitry are configured to perform operations corresponding to any of the methods of embodiments A1-A11.
C2. A user equipment (UE) configured for application-layer measurements in a radio access network (RAN), the UE being further configured to perform operations corresponding to any of the methods of embodiments A1-A11.
C3. A non-transitory, computer-readable medium storing computer-executable instructions that, when executed by processing circuitry of a user equipment (UE) configured for application-layer measurements in a radio access network (RAN), configure the UE to perform operations corresponding to any of the methods of embodiments A1-A11.
C4. A computer program product comprising computer-executable instructions that, when executed by processing circuitry of a user equipment (UE) configured for application-layer measurements in a radio access network (RAN), configure the UE to perform operations corresponding to any of the methods of embodiments A1-A11.
D1. A radio access network (RAN) node configured to manage application-layer measurements by user equipment (UEs) in the RAN, the RAN node comprising:
   communication interface circuitry configured to communicate with UEs and with one or more further RAN nodes; and
   processing circuitry operatively coupled to the communication interface circuitry, whereby the processing circuitry and the communication interface circuitry are configured to perform operations corresponding to any of the methods of embodiments B1-B8.
D2. A radio access network (RAN) node configured to manage application-layer measurements by user equipment (UEs) in the RAN, the RAN node being further configured to perform operations corresponding to any of the methods of embodiments B1-B8.
D3. A non-transitory, computer-readable medium storing computer-executable instructions that, when executed by processing circuitry of a radio access network (RAN) node configured to manage application-layer measurements by user equipment (UEs) in the RAN, configure the RAN node to perform operations corresponding to any of the methods of embodiments B1-B8.
D4. A computer program product comprising computer-executable instructions that, when executed by processing circuitry of a radio access network (RAN) node configured to manage application-layer measurements by user equipment (UEs) in the RAN, configure the RAN node to perform operations corresponding to any of the methods of embodiments B1-B8.

1.-28. (canceled)

29. A method for a user equipment (UE) configured for application-layer measurements in a radio access network (RAN), the method comprising:
receiving one or more configurations of application-layer measurements to be performed by the UE while the UE is connected to the RAN;
in response to an interruption in the UE's connection to the RAN while the UE is configured to perform the application-layer measurements, sending one of the following requests to the RAN: a request to resume the UE's connection, or a request to reestablish the UE's connection;
in response to the request sent to the RAN, receiving from the RAN a command to setup a new connection to the RAN; and
in response to the command, releasing the received configurations and discarding any stored application-layer measurement reports.

30. The method of claim 29, further comprising, for each of the received configurations, initiating a timer associated with the configuration in response to one of the following: receiving the configuration, receiving the command, or sending to the RAN an application-layer measurement report associated with the configuration.

31. The method of claim 30, further comprising, after initiating a timer associated with a configuration:
maintaining any stored application-layer measurement reports associated with the configuration, until the earlier of the following: expiration of the timer, and connecting to the RAN via a RAN node that supports the configuration; and
releasing the configuration and discarding any stored application-layer measurement reports associated with the configuration, after expiration of the timer without connecting to the RAN via a RAN node that supports the configuration.

32. The method of claim 31, further comprising, upon connecting to the RAN via a RAN node that supports the configuration, sending the following to the RAN node:
any stored application-layer measurement reports associated with the configuration, and
an identifier of an intended recipient measurement collection entity (MCE).

33. The method of claim 29, wherein receiving the command implicitly indicates that the UE should release the received configurations and discard any stored application-layer measurement reports.

34. The method of claim 29, wherein one of the following applies:
the one or more configurations are received from a first RAN node, and the request is sent to and the command is received from a second RAN node; or
the one or more configurations are received from, the request is sent to, and the command is received from a single RAN node.

35. The method of claim 29, wherein the application-layer measurements are quality-of-experience (QoE) measurements.

36. The method of claim 29, wherein:
the interruption in the UE's connection to the RAN is based on the UE's connection being suspended to an inactive state; and
the request is a request to resume the UE's suspended connection.

37. A method for a radio access network (RAN) node configured to manage application-layer measurements by user equipment (UEs), the method comprising:
receiving one of the following requests from a UE that was previously provided with one or more configurations of application-layer measurements to be performed by the UE while connected to the RAN:
a request to resume the UE's connection to the RAN, or
a request to reestablish the UE's connection to the RAN; and
in response to the request from the UE, sending the UE a command to setup a new connection to the RAN, wherein the command implicitly indicates that the UE should release the one or more configurations previously provided to the UE and discard any stored application-layer measurement reports.

38. The method of claim 37, further comprising determining one of the following in response to the request from the UE:
a failure occurred during attempted retrieval of a UE context stored in the RAN; or
at least a portion of the one or more configurations is undesirable for the RAN node,
wherein the command to setup the new connection is sent to the UE in response to the determination.

39. The method of claim 38, wherein the failure during attempted retrieval of the UE context is one of the following:
the UE context is unavailable to be retrieved; or
the RAN node is unable to interpret or understand some portion of the retrieved UE context.

40. The method of claim 38, wherein determining that at least a portion of the one or more configurations is undesirable for the RAN node comprises successfully retrieving the UE context stored in the RAN, wherein the retrieved UE context includes the at least a portion of the one or more configurations.

41. The method of claim 40, wherein determining that at least a portion of the one or more configurations is undesirable for the RAN node further comprises determining one or more of the following based on the retrieved UE context:
the RAN node does not support one or more features associated with the at least a portion;
the RAN node does not have resources available to support the at least a portion; and
an area served by the RAN node is not within a measurement area associated with the at least a portion.

42. The method of claim 37, wherein:
the one or more configurations were provided to the UE by the RAN node; and
the method further comprises deleting a UE context stored by the RAN node before receiving the request, wherein the stored UE context includes the one or more configurations.

43. The method of claim 37, wherein the one or more configurations were provided to the UE by a further RAN node.

44. The method of claim 37, wherein the application-layer measurements are quality-of-experience (QoE) measurements.

45. A user equipment (UE) configured for application-layer measurements in a radio access network (RAN), the UE comprising:
communication interface circuitry configured to communicate with one or more RAN nodes; and
processing circuitry operatively coupled to the communication interface circuitry, whereby the processing circuitry and the communication interface circuitry are configured to:
receive one or more configurations of application-layer measurements to be performed by the UE while the UE is connected to the RAN;
in response to an interruption in the UE's connection to the RAN while the UE is configured to perform the application-layer measurements, send one of the following requests to the RAN: a request to resume the UE's connection, or a request to reestablish the UE's connection;
in response to the request sent to the RAN, receive from the RAN a command to setup a new connection to the RAN; and
in response to the command, release the received configurations and discard any stored application-layer measurement reports.

46. The UE of claim 45, wherein the processing circuitry and the communication interface circuitry are further configured to, for each of the received configurations:
initiating a timer associated with the configuration in response to one of the following: receiving the configuration, receiving the command, or sending to the RAN an application-layer measurement report associated with the configuration.
maintaining any stored application-layer measurement reports associated with the configuration, until the earlier of the following: expiration of the associated timer, and connecting to the RAN via a RAN node that supports the configuration; and
releasing the configuration and discarding any stored application-layer measurement reports associated with the configuration, after expiration of the associated timer without connecting to the RAN via a RAN node that supports the configuration.

47. The UE of claim 45, wherein reception of the command by the processing circuitry and the communication interface implicitly indicates that the UE should release the received configurations and discard any stored application-layer measurement reports.

48. A non-transitory, computer-readable medium storing computer-executable instructions that, when executed by processing circuitry of a user equipment (UE) configured for application-layer measurements in a radio access network (RAN), configure the UE to perform operations corresponding to the method of claim 29.

49. A radio access network (RAN) node configured to manage application-layer measurements by user equipment (UEs), the RAN node comprising:
communication interface circuitry configured to communicate with UEs and with one or more further RAN nodes; and
processing circuitry operatively coupled to the communication interface circuitry, whereby the processing circuitry and the communication interface circuitry are configured to:
receive one of the following requests from a UE that was previously provided with one or more configurations of application-layer measurements to be performed by the UE while connected to the RAN:
a request to resume the UE's connection to the RAN, or
a request to reestablish the UE's connection to the RAN; and
in response to the request from the UE, send the UE a command to setup a new connection to the RAN, wherein the command implicitly indicates that the UE should release the one or more configurations previously provided to the UE and discard any stored application-layer measurement reports.

50. The RAN node of claim 49, wherein the processing circuitry and the communication interface circuitry are further configured to:
determine one of the following in response to the request from the UE:
a failure occurred during attempted retrieval of a UE context stored in the RAN; or
at least a portion of the one or more configurations is undesirable for the RAN node; and
send the command to setup the new connection to the UE in response to the determination.

51. The RAN node of claim 49, wherein the one or more configurations were provided to the UE by the RAN node, and the processing circuitry and the communication interface circuitry are further configured to delete a UE context stored by the RAN node before receiving the request, wherein the stored UE context includes the one or more configurations.

52. A non-transitory, computer-readable medium storing computer-executable instructions that, when executed by processing circuitry of a radio access network (RAN) node configured to manage application-layer measurements by user equipment (UEs), configure the RAN node to perform operations corresponding to the method of claim 37.
